(19) United States
(12) Patent Application Publication
(10) Pub. No.: US 2024/0397559 A1
(43) Pub. Date: Nov. 28, 2024

(54) METHOD AND DEVICE IN NODES USED FOR WIRELESS COMMUNICATION

(71) Applicants: Yang HU, Shanghai (CN); Xiaobo ZHANG, Shanghai (CN)

(72) Inventors: Yang HU, Shanghai (CN); Xiaobo ZHANG, Shanghai (CN)

(73) Assignee: SHANGHAI TUILUO COMMUNICATION TECHNOLOGY PARTNERSHIP (LIMITED PARTNERSHIP), Shanghai, OT (CN)

(21) Appl. No.: 18/770,685

(22) Filed: Jul. 12, 2024

Related U.S. Application Data
(63) Continuation of application No. PCT/CN2023/072012, filed on Jan. 13, 2023.

(30) Foreign Application Priority Data
Jan. 20, 2022 (CN) 202210063326.3

(51) Int. Cl. H04W 74/0833; H04W 72/0446

(52) U.S. Cl. CPC H04W 74/0833; H04W 72/0446

(57) ABSTRACT

The present application provides a method and device in a node for wireless communications. A first transmitter transmits a first preamble in a first PRACH occasion; a first receiver receives a first signaling, and the first signaling adopts a first RNTI; wherein the first signaling is used to respond to a transmission of the first preamble; a first time-domain symbol is an earliest time-domain symbol of the first PRACH occasion; an index of a reference time-domain symbol and an index of a reference slot are both used to determine the first RNTI, the reference time-domain symbol is a time-domain symbol other than the first time-domain symbol, and the reference time-domain symbol belongs to the reference slot; a time-domain position of the reference time-domain symbol is related to at least one of the first PRACH occasion or the first preamble.

### CROSS REFERENCE TO RELATED APPLICATIONS

This application is the continuation of the international patent application No. PCT/CN2023/072012, filed on Jan. 13, 2023, and claims the priority benefit of Chinese Patent Application No. 202210063326.3, filed on Jan. 20, 2022, the full disclosure of which is incorporated herein by reference.

### BACKGROUND

### Technical Field

The present application relates to transmission methods and devices in wireless communication systems, and in particular to a transmission method and device of a radio signal in a wireless communication system supporting cellular networks.

### Related Art

Random Access is an important aspect of uplink (UL) transmission; enhancing PRACH (Physical Random Access Channel) is an important issue in enhancing uplink coverage. How to determine relevant configuration used for random access after adopting coverage enhancement technology for PRACH is a key issue that must be addressed.

### SUMMARY

To address the above problem, the present application provides a solution. It should be noted that the above description uses uplink in cellular networks as an example; the present application is also applicable to other scenarios, such as IoT (Internet of Things), Internet of Vehicles, NTN (non-terrestrial networks), etc., where similar technical effects can be achieved. In addition, the adoption of a unified solution for different scenarios (including but not limited to cellular networks, IoT, IoV, NTN) can also help to reduce hardware complexity and cost, or improve performance. If no conflict is incurred, embodiments in any node in the present application and the characteristics of the embodiments are also applicable to any other node, and vice versa. And the embodiments in the present application and the characteristics in the embodiments can be arbitrarily combined if there is no conflict.

In one embodiment, interpretations of the terminology in the present application refer to definitions given in the 3GPP TS36 series.

In one embodiment, interpretations of the terminology in the present application refer to definitions given in the 3GPP TS38 series.

In one embodiment, interpretations of the terminology in the present application refer to definitions given in the 3GPP TS37 series.

In one embodiment, interpretations of the terminology in the present application refer to definitions given in Institute of Electrical and Electronics Engineers (IEEE) protocol specifications.

The present application provides a method in a first node for wireless communications, comprising:
transmitting a first preamble in a first PRACH occasion; and
receiving a first signaling, and the first signaling adopting a first RNTI;
herein, the first signaling is used to respond to a transmission of the first preamble; a first time-domain symbol is an earliest time-domain symbol of the first PRACH occasion; an index of a reference time-domain symbol and an index of a reference slot are both used to determine the first RNTI, the reference time-domain symbol is a time-domain symbol other than the first time-domain symbol, and the reference time-domain symbol belongs to the reference slot; a time-domain position of the reference time-domain symbol is related to at least one of the first PRACH occasion or the first preamble.

In one embodiment, advantages of the above method comprise: being conducive to implement an enhancement of uplink coverage performance.

In one embodiment, advantages of the above method comprise: improving flexibility in base station configuration is beneficial for overall system performance improvement.

In one embodiment, advantages of the above method comprise: avoiding ambiguous understanding of RAR related configurations by both communication parties.

In one embodiment, advantages of the above method comprise: being conducive to the full utilization of RNTI resources.

In one embodiment, advantages of the above method comprise: improving the transmission performance or resource utilization of uplink.

According to one aspect of the present application, the above method is characterized in that
the reference time-domain symbol is an earliest time-domain symbol occupied by a first reference PRACH occasion in time domain, and time-domain resources occupied by the first reference PRACH occasion are later than time-domain resources occupied by the first reference PRACH occasion.

According to one aspect of the present application, the above method is characterized in that
the first PRACH occasion and the first reference PRACH occasion are both associated with a same SS/PBCH block index.

According to one aspect of the present application, the above method is characterized in that
the first PRACH occasion and the first reference PRACH occasion are associated with different SS/PBCH block indexes, respectively.

According to one aspect of the present application, the above method is characterized in that
a second reference PRACH occasion does not overlap with the first reference PRACH occasion in time domain, and the second reference PRACH occasion is used to determine a first time window, the first time window is an RAR time window for the first preamble, and the first signaling is detected in the first time window.

In one embodiment, advantages of the above method comprise: supporting the initiation of the RAR time window after multiple repetitions of PRACH, which improves the transmission performance of PRACH while ensuring the consistency of the communication parties' understanding of the RAR time window.

In one embodiment, advantages of the above method comprise: increasing flexibility of configuration.

In one embodiment, advantages of the above method comprise: being conducive to choosing an appropriate compromise between the transmission reliability of PRACH and the delay of random access.

In one embodiment, advantages of the above method comprise: being conducive to reducing the delay of random access.

In one embodiment, advantages of the above method comprise: avoiding unnecessary missed RAR detection.

According to one aspect of the present application, the above method is characterized in comprising:
receiving first information;
herein, a first PRACH occasion pool comprises multiple PRACH occasions, a first PRACH occasion group comprises multiple PRACH occasions, and all PRACH occasions in the first PRACH occasion group belong to the first PRACH occasion pool; the first PRACH occasion belongs to the first PRACH occasion group, and each PRACH occasion in the first PRACH occasion group is used to transmit a repetition of the first preamble, the first information is used to determine the first PRACH occasion group from the first PRACH occasion pool.

According to one aspect of the present application, the above method is characterized in that
the first PRACH occasion pool is divided into multiple PRACH occasion groups; the first information is used to determine at least one valid PRACH occasion group from the multiple PRACH occasion groups, and each valid PRACH occasion group in the multiple PRACH occasion groups is reserved for a transmission of a preamble; the first PRACH occasion group is a valid PRACH occasion group among the multiple PRACH occasion groups.

In one embodiment, advantages of the above method comprise: enhancing the transmission performance of PRACH.

The present application provides a method in a second node for wireless communications, comprising:
receiving a first preamble in a first PRACH occasion; and
transmitting a first signaling, and the first signaling adopting a first RNTI;
herein, the first signaling is used to respond to a transmission of the first preamble; a first time-domain symbol is an earliest time-domain symbol of the first PRACH occasion; an index of a reference time-domain symbol and an index of a reference slot are both used to determine the first RNTI, the reference time-domain symbol is a time-domain symbol other than the first time-domain symbol, and the reference time-domain symbol belongs to the reference slot; a time-domain position of the reference time-domain symbol is related to at least one of the first PRACH occasion or the first preamble.

According to one aspect of the present application, the above method is characterized in that
the reference time-domain symbol is an earliest time-domain symbol occupied by a first reference PRACH occasion in time domain, and time-domain resources occupied by the first reference PRACH occasion are later than time-domain resources occupied by the first reference PRACH occasion.

According to one aspect of the present application, the above method is characterized in that
the first PRACH occasion and the first reference PRACH occasion are both associated with a same SS/PBCH block index.

According to one aspect of the present application, the above method is characterized in that
the first PRACH occasion and the first reference PRACH occasion are associated with different SS/PBCH block indexes, respectively.

According to one aspect of the present application, the above method is characterized in that
a second reference PRACH occasion does not overlap with the first reference PRACH occasion in time domain, and the second reference PRACH occasion is used to determine a first time window, the first time window is an RAR time window for the first preamble, and the first signaling is transmitted in the first time window.

According to one aspect of the present application, the above method is characterized in comprising:
transmitting first information;
herein, a first PRACH occasion pool comprises multiple PRACH occasions, a first PRACH occasion group comprises multiple PRACH occasions, and all PRACH occasions in the first PRACH occasion group belong to the first PRACH occasion pool; the first PRACH occasion belongs to the first PRACH occasion group, and each PRACH occasion in the first PRACH occasion group is used to transmit a repetition of the first preamble, the first information is used to determine the first PRACH occasion group from the first PRACH occasion pool.

According to one aspect of the present application, the above method is characterized in that
the first PRACH occasion pool is divided into multiple PRACH occasion groups; the first information is used to determine at least one valid PRACH occasion group from the multiple PRACH occasion groups, and each valid PRACH occasion group in the multiple PRACH occasion groups is reserved for a transmission of a preamble; the first PRACH occasion group is a valid PRACH occasion group among the multiple PRACH occasion groups.

The present application provides a first node for wireless communications, comprising:
a first transmitter, transmitting a first preamble in a first PRACH occasion; and
a first receiver, receiving a first signaling, and the first signaling adopting a first RNTI;
herein, the first signaling is used to respond to a transmission of the first preamble; a first time-domain symbol is an earliest time-domain symbol of the first PRACH occasion; an index of a reference time-domain symbol and an index of a reference slot are both used to determine the first RNTI, the reference time-domain symbol is a time-domain symbol other than the first time-domain symbol, and the reference time-domain symbol belongs to the reference slot; a time-domain position of the reference time-domain symbol is related to at least one of the first PRACH occasion or the first preamble.

The present application provides a second node for wireless communications, comprising:
a second receiver, receiving a first preamble in a first PRACH occasion; and
a second transmitter, transmitting a first signaling, the first signaling adopting a first RNTI;
herein, the first signaling is used to respond to a transmission of the first preamble; a first time-domain symbol is an earliest time-domain symbol of the first PRACH occasion; an index of a reference time-domain symbol and an index of a reference slot are both used to determine the first RNTI, the reference time-domain symbol is a time-domain symbol other than the first time-domain symbol, and the reference time-domain symbol belongs to the reference slot; a time-domain position of the reference time-domain symbol is related to at least one of the first PRACH occasion or the first preamble.

In one embodiment, the method in the present application is advantageous in the following aspects:
enhancing the transmission performance of uplink;
improving the flexibility in base station scheduling;
improving the spectral efficiency;
avoiding ambiguous understanding of RAR related configurations by both communication parties;
being beneficial for the full utilization of RNTI resources.

### BRIEF DESCRIPTION OF THE DRAWINGS

Other features, objects and advantages of the present application will become more apparent from the detailed description of non-restrictive embodiments taken in conjunction with the following drawings:

FIG. 1 illustrates a flowchart of the processing of a first node according to one embodiment of the present application;

FIG. 2 illustrates a schematic diagram of a network architecture according to one embodiment of the present application;

FIG. 3 illustrates a schematic diagram of a radio protocol architecture of a user plane and a control plane according to one embodiment of the present application;

FIG. 4 illustrates a schematic diagram of a first communication device and a second communication device according to one embodiment of the present application;

FIG. 5 illustrates a flowchart of signal transmission according to one embodiment of the present application;

FIG. 6 illustrate a schematic diagram of relations between a first PRACH occasion and a first PRACH occasion group according to one embodiment of the present application;

FIG. 7 illustrates a schematic diagram of a first RNTI according to one embodiment of the present application;

FIG. 8 illustrates a schematic diagram of relations among a second reference PRACH occasion, a first reference PRACH occasion, a first time window and a first preamble according to one embodiment of the present application;

FIG. 9 illustrates a schematic diagram of a second reference PRACH occasion being used to determine a first time window according to one embodiment of the present application;

FIG. 10 illustrates a schematic diagram of relations among a first node, first information, a first PRACH occasion, a first PRACH occasion group and a first PRACH occasion pool according to one embodiment of the present application;

FIG. 11 illustrates a schematic diagram of relations among first information, a first PRACH occasion group, multiple PRACH occasion groups and a first PRACH occasion pool according to one embodiment of the present application;

FIG. 12 illustrates a structure block diagram of a processor in a first node according to one embodiment of the present application;

FIG. 13 illustrates a structure block diagram of a processor in second node according to one embodiment of the present application.

### DESCRIPTION OF THE EMBODIMENTS

The technical solution of the present application will be further described in detail below in combination with the drawings. It should be noted that, in the case of no conflict, the embodiments of the present application and the features in the embodiments may be combined with each other arbitrarily.

### Embodiment 1

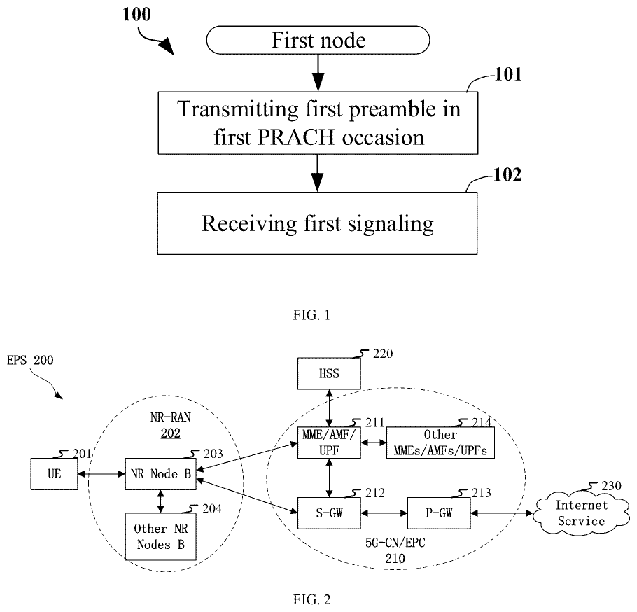

Embodiment 1 illustrates a flowchart of processing of a first node according to one embodiment of the present application, as shown in FIG. 1.

In Embodiment 1, the first node in the present application transmits a first preamble in a first PRACH occasion in step 101; and receives a first signaling in step 102.

In embodiment 1, the first signaling adopts a first RNTI; the first signaling is used to respond to a transmission of the first preamble; a first time-domain symbol is an earliest time-domain symbol of the first PRACH occasion; an index of a reference time-domain symbol and an index of a reference slot are both used to determine the first RNTI, the reference time-domain symbol is a time-domain symbol other than the first time-domain symbol, and the reference time-domain symbol belongs to the reference slot; a time-domain position of the reference time-domain symbol is related to at least one of the first PRACH occasion or the first preamble.

In one embodiment, the first PRACH occasion is a PRACH occasion.

In one embodiment, a PRACH occasion in the present application comprises time-frequency resources used for transmitting a preamble.

In one embodiment, a PRACH occasion in the present application is reserved for a transmission of a preamble.

In one embodiment, a PRACH occasion in the present application is reserved for a transmission of a preamble or a repetition of a preamble.

In one embodiment, a PRACH occasion in the present application is reserved for a transmission of a PRACH.

In one embodiment, a PRACH occasion in the present application is reserved for a transmission of PRACH or a repetition of PRACH.

In one embodiment, a PRACH occasion in the present application occupies a positive integer number of time-domain symbol(s) in time domain.

In one embodiment, a PRACH occasion in the present application occupies a positive integer number of subcarrier(s) in frequency domain.

In one embodiment, the first preamble is a preamble.

In one embodiment, the first preamble is a preamble sequence.

In one embodiment, Zhadoff-Chu sequence is used to generate the first preamble.

In one embodiment, the first preamble is a preamble used for random access.

In one embodiment, the first preamble is a preamble used for carrying Msg1.

In one embodiment, the first preamble adopts a short preamble format.

In one embodiment, the first preamble adopts one of preamble format 0, preamble format 1, preamble format 2, or preamble format 3.

In one embodiment, the first preamble adopts one of preamble format A1, preamble format A2, or preamble format A3

In one embodiment, the first preamble adopts one of preamble format B1, preamble format B2, preamble format B3, or preamble format B4.

In one embodiment, the first preamble adopts one of preamble format CO, or preamble format C2.

In one embodiment, a sequence length of the first preamble is 839.

In one embodiment, a sequence length of the first preamble is 139.

In one embodiment, a sequence length of the first preamble is 571.

In one embodiment, a sequence length of the first preamble is 1151.

In one embodiment, an SCS (subcarrier spacing) corresponding to the first preamble is 1.25 kHz.

In one embodiment, an SCS corresponding to the first preamble is 5 kHz

In one embodiment, an SCS corresponding to the first preamble is 15 kHz.

In one embodiment, an SCS corresponding to the first preamble is 30 KHz.

In one embodiment, an SCS corresponding to the first preamble is 60 KHz.

In one embodiment, an SCS corresponding to the first preamble is 120 KHz.

In one embodiment, the first PRACH occasion is higher-layer signaling configured.

In one embodiment, the first PRACH occasion is RRC-signaling configured.

In one embodiment, the first PRACH occasion is configured in an IE RACH-ConfigCommon.

In one embodiment, the first PRACH occasion is configured in an IE RACH-ConfigDedicated.

In one embodiment, the first PRACH occasion is configured in an IE RACH-ConfigGeneric.

In one embodiment, the first PRACH occasion is configured in an IE whose name comprises RACH.

In one embodiment, the first PRACH occasion is configured by an SIB message.

In one embodiment, the first PRACH occasion is configured by SIB1.

In one embodiment, the first PRACH occasion is pre-defined.

In one embodiment, the first signaling is a DCI.

In one embodiment, the first signaling is DCI format 1_0.

In one embodiment, the first signaling is used to schedule a PDSCH.

In one embodiment, a CRC (Cyclic redundancy check) bit of the first signaling is scrambled by the first RNTI.

In one embodiment, the first signaling comprises an RAR UL grant to physical layer.

In one embodiment, the first signaling comprises a MAC RAR.

In one embodiment, the first signaling belongs to a MAC PDU.

In one embodiment, the first signaling comprises at least one bit.

In one embodiment, the first signaling is denoted by at least one bit.

In one embodiment, the first signaling is a physical-layer signaling.

In one embodiment, the first signaling is a Downlink control information (DCI) format.

In one embodiment, the first signaling is a DCI signaling.

In one embodiment, the first signaling is DCI format 1_0.

In one embodiment, the first signaling is DCI format 0_0, and for the specific meaning of the DCI format 0_0, refer to chapter 7.3.1.1 in 3GPP TS38.212.

In one embodiment, the first signaling is DCI format 0_1, and for the specific meaning of the DCI format 0_1, refer to chapter 7.3.1.1 in 3GPP TS38.212.

In one embodiment, the first signaling is DCI format 0_2, and for the specific meaning of the DCI format 0_2, refer to chapter 7.3.1.1 in 3GPP TS38.212.

In one embodiment, the first signaling is DCI format 1_0, and for the specific meaning of the DCI format 1_0, refer to chapter 7.3.1.2 in 3GPP TS38.212.

In one embodiment, the first signaling is DCI format 1_1, and for the specific meaning of the DCI format 1_1, refer to chapter 7.3.1.2 in 3GPP TS38.212.

In one embodiment, the first signaling is DCI format 1_2, and for the specific meaning of the DCI format 1_2, refer to chapter 7.3.1.2 in 3GPP TS38.212.

In one embodiment, the first signaling comprises one or multiple fields in a DCI format.

In one embodiment, the first signaling is an UpLink Grant Signalling.

In one embodiment, the first signaling is a DownLink Grant Signalling.

In one embodiment, the first signaling is a higher-layer signaling.

In one embodiment, the first signaling is an RRC signaling.

In one embodiment, the first signaling comprises one or multiple fields in an RRC signaling.

In one embodiment, the first signaling comprises an IE (Information Element).

In one embodiment, the second signaling comprises one or multiple fields in an IE.

In one embodiment, the first signaling is a Medium Access Control layer Control Element (MAC CE).

In one embodiment, the first signaling comprises one or multiple fields of a MAC CE.

In one embodiment, the first signaling belongs to a MAC CE.

In one embodiment, the meaning of the expression that “transmitting a first preamble in a first PRACH occasion” comprises: transmitting the first preamble within time-frequency resources occupied by the first PRACH occasion.

In one embodiment, the meaning of the expression that “transmitting a first preamble in a first PRACH occasion” comprises: using the first PRACH occasion to transmit the first preamble.

In one embodiment, the first RNTI is a Radio Network Temporary Identification (RNTI) used for random access.

In one embodiment, the first RNTI is an RA-RNTI.

In one embodiment, the first RNTI is an MsgB RNTI.

In one embodiment, the expression that “the first signaling adopts a first RNTI” comprises: the first RNTI is used to perform scrambling on the first signaling.

In one embodiment, the expression that “the first signaling adopts a first RNTI” comprises: a CRC of the first signaling is scrambled by the first RNTI.

In one embodiment, the first signaling is DCI format 1_0, a CRC of the first signaling is scrambled by the first RNTI, and the first RNTI is an RA-RNTI.

In one embodiment, the expression that “the first signaling adopts a first RNTI” comprises: a PDSCH scheduled by a DCI format whose comprised CRC is scrambled by the first RNTI is used to carry the first signaling.

In one embodiment, the expression that “the first signaling is used to respond to a transmission of the first preamble” comprises: the first signaling comprises an RAR for the first preamble.

In one embodiment, the expression that “the first signaling is used to respond to a transmission of the first preamble” comprises: the first signaling comprises a RAPID corresponding to the first preamble and a random access response (RAR) UL grant to the physical layer

In one embodiment, the expression that “the first signaling is used to respond to a transmission of the first preamble” comprises: the first signaling is used to schedule a PDSCH carrying at least RAR for the first preamble.

In one embodiment, the expression that “the first signaling is used to respond to a transmission of the first preamble” comprises: the first signaling is used to schedule a PDSCH that carries at least an RAPID corresponding to the first preamble and an RAR uplink grant to the physical layer.

In one embodiment, the first signaling is used to schedule a PDSCH carrying at least an RAPID corresponding to the first preamble and a MAC RAR.

In one embodiment, the expression that “the first signaling is used to respond to a transmission of the first preamble” comprises: LSBs of SFN field comprised in the first signaling is the same as corresponding LSBs of an SFN to which a transmission of the first preamble belongs in time domain, and a TB in PDSCH scheduled by the first signaling is received in a first time window, and the TB is transferred to higher layers to be parsed to obtain an RAPID (random access preamble identity/identifier) corresponding to the first preamble; the first time window is an RAR (Random Access Response) time window for the first preamble.

In one embodiment, the RAR time window is a time window used to monitor a random access response.

In one embodiment, the first time-domain symbol comprises consecutive time-domain resources.

In one embodiment, the time-domain symbol in the present application comprises consecutive time-domain resources.

In one embodiment, the time-domain symbol in the present application is a multicarrier symbol.

In one embodiment, the time-domain symbol in the present application is an Orthogonal Frequency Division Multiplexing (OFDM) symbol.

In one embodiment, the time-domain symbol in the present application is a Single Carrier-Frequency Division Multiple Access (SC-FDMA) symbol.

In one embodiment, the time-domain symbol in the present application is a Discrete Fourier Transform Spread OFDM (DFT-S-OFDM) symbol.

In one embodiment, the time-domain symbol in the present application is a Filter Bank Multicarrier (FBMC) symbol.

In one embodiment, the time-domain symbol in the present application are specific to a 15 kHz parameter set (numerology).

In one embodiment, the time-domain symbol in the present application are specific to a 30 KHz parameter set (numerology).

In one embodiment, the time-domain symbol in the present application are specific to a 60 KHz parameter set (numerology).

In one embodiment, the time-domain symbol in the present application are specific to a 120 kHz parameter set (numerology).

In one embodiment, an index of a time-domain symbol in the present application is a non-negative integer.

In one embodiment, an index of a time-domain symbol in the present application refers to an index of the time-domain symbol in a slot it belongs to.

In one embodiment, a value range for indexes of time-domain symbols in the present application is 0 to 13.

In one embodiment, an index of a slot in the present application is a non-negative integer.

In one embodiment, an index of a slot in the present application refers to an index of the slot in a system frame to which it belongs.

In one embodiment, a value of an index of a slot in the present application ranges from 0 to 79.

In one embodiment, a first slot is a slot to which the first time-domain symbol belongs, and the reference slot is not the first slot.

In one embodiment, the reference slot is before the first slot.

In one embodiment, the reference slot is after the first slot.

In one embodiment, a slot in the present application comprises multiple time-domain symbols.

In one embodiment, the first RNTI is linearly correlated with the index of the reference time-domain symbol.

In one embodiment, the first RNTI is linearly correlated with the index of the reference slot.

In one embodiment, the index of the reference time-domain symbol and the index of the reference slot jointly indicate the first RNTI.

In one embodiment, the index of the reference time-domain symbol and the index of the reference slot are used to calculate the first RNTI.

In one embodiment, the first RNTI is equal to a sum of multiple addends, one of the multiple addends is equal to the index of the reference time-domain symbol, and another one of the multiple addends is equal to 14 times the index of the reference slot.

In one embodiment, the first RNTI=1+s+14×t; herein, the s denotes the index of the reference time-domain symbol, and the t denotes the index of the reference slot.

In one embodiment, the first RNTI=1+s+7×t; herein, the s denotes the index of the reference time-domain symbol, and the t denotes the index of the reference slot.

In one embodiment, the first RNTI=max (s, t); herein, the s denotes the index of the reference time-domain symbol, and the t denotes the index of the reference slot.

In one embodiment, the reference time-domain symbol is before the first time-domain symbol.

In one embodiment, the reference time-domain symbol is after the first time-domain symbol.

In one embodiment, the reference time-domain symbol is a time-domain symbol used for transmitting the first preamble.

In one embodiment, the reference time-domain symbol is an earliest time-domain symbol used for transmitting the first preamble.

In one embodiment, the reference time-domain symbol is located after a latest time-domain symbol occupied by the first PRACH occasion in time domain.

In one embodiment, the expression that “a time-domain position of the reference time-domain symbol is related to at least one of the first PRACH occasion or the first preamble” comprises: the reference time-domain symbol is before the first time-domain symbol.

In one embodiment, the reference time-domain symbol is an earliest time-domain symbol of a first reference PRACH occasion, and the first PRACH occasion does not overlap with the first reference PRACH in time domain.

In one embodiment, the reference time-domain symbol is an earliest time-domain symbol of a first reference PRACH occasion, and time-domain resources of the first PRACH occasion are earlier than time-domain resources of the first reference PRACH occasion.

### Embodiment 2

Embodiment 2 illustrates a schematic diagram of a network architecture according to the present application, as shown in FIG. 2.

FIG. 2 illustrates a network architecture 200 of 5G NR, Long-Term Evolution (LTE) and Long-Term Evolution Advanced (LTE-A) systems. The NR 5G or LTE network architecture 200 may be called an Evolved Packet System (EPS) 200 or other appropriate terms. The EPS 200 may comprise one or more UEs 201, an NG-RAN 202, an Evolved Packet Core/5G-Core Network (EPC/5G-CN) 210, a Home Subscriber Server (HSS) 220 and an Internet Service 230. The EPS 200 may be interconnected with other access networks. For simple description, the entities/interfaces are not shown. As shown in FIG. 2, the EPS 200 provides packet switching services. Those skilled in the art will readily understand that various concepts presented throughout the present application can be extended to networks providing circuit switching services or other cellular networks. The NG-RAN 202 comprises an NR node B (gNB) 203 and other gNBs 204. The gNB 203 provides UE 201-oriented user plane and control plane protocol terminations. The gNB 203 may be connected to other gNBs 204 via an Xn interface (for example, backhaul). The gNB 203 may be called a base station, a base transceiver station, a radio base station, a radio transceiver, a transceiver function, a Base Service Set (BSS), an Extended Service Set (ESS), a Transmitter Receiver Point (TRP) or some other applicable terms. The gNB 203 provides an access point of the EPC/5G-CN 210 for the UE 201. Examples of the UE 201 include cellular phones, smart phones, Session Initiation Protocol (SIP) phones, laptop computers, Personal Digital Assistant (PDA), satellite Radios, non-terrestrial base station communications, Satellite Mobile Communications, Global Positioning Systems (GPSs), multimedia devices, video devices, digital audio players (for example, MP3 players), cameras, game consoles, unmanned aerial vehicles (UAV), aircrafts, narrow-band Internet of Things (IoT) devices, machine-type communication devices, land vehicles, automobiles, wearable devices, or any other similar functional devices. Those skilled in the art also can call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy; a mobile client, a client or some other appropriate terms. The gNB 203 is connected to the EPC/5G-CN 210 via an SI/NG interface. The EPC/5G-CN 210 comprises a Mobility Management Entity (MME)/Authentication Management Field (AMF)/User Plane Function (UPF) 211, other MMEs/AMFs/UPFs 214, a Service Gateway (S-GW) 212 and a Packet Date Network Gateway (P-GW) 213. The MME/AMF/UPF 211 is a control node for processing a signaling between the UE 201 and the EPC/5G-CN 210. Generally; the MME/AMF/UPF 211 provides bearer and connection management. All user Internet Protocol (IP) packets are transmitted through the S-GW 212, the S-GW 212 is connected to the P-GW 213. The P-GW 213 provides UE IP address allocation and other functions. The P-GW 213 is connected to the Internet Service 230. The Internet Service 230 comprises IP services corresponding to operators, specifically including Internet, Intranet, IP Multimedia Subsystem (IMS) and Packet Switching Streaming Services (PSS).

In one embodiment, the UE 201 corresponds to the first node in the present application.

In one embodiment, the UE 201 corresponds to the second node in the present application.

In one embodiment, the gNB 203 corresponds to the first node in the present application.

In one embodiment, the gNB 203 corresponds to the second node in the present application.

In one embodiment, the UE 201 corresponds to the first node in the present application, and the gNB 203 corresponds to the second node in the present application.

In one embodiment, the gNB 203 is a MarcoCellular base station.

In one embodiment, the gNB 203 is a Micro Cell base station.

In one embodiment, the gNB 203 is a PicoCell base station.

In one embodiment, the gNB 203 is a Femtocell.

In one embodiment, the gNB 203 is a base station that supports large delay differences.

In one embodiment, the gNB 203 is a flight platform.

In one embodiment, the gNB 203 is satellite equipment.

In one embodiment, both the first node and the second node in the present application correspond to the UE 201, for example, V2X communications are performed between the first node and the second node.

### Embodiment 3

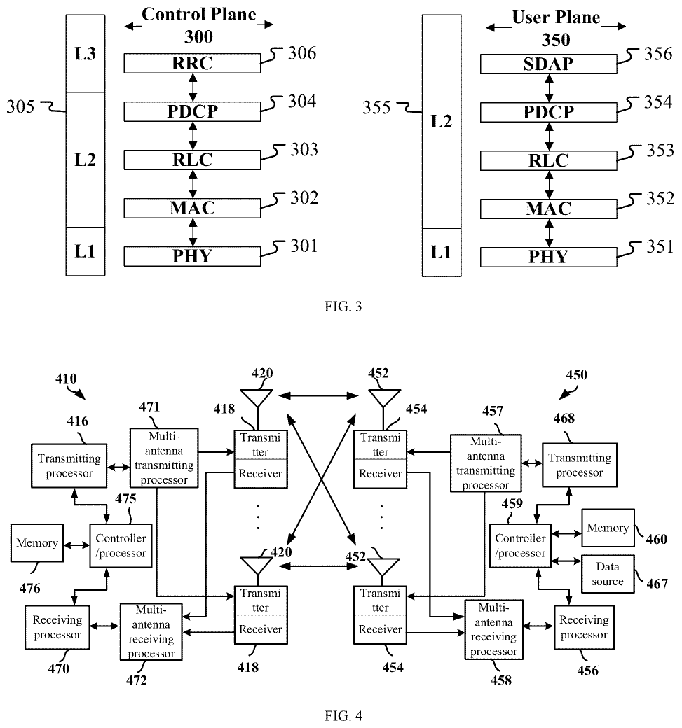

Embodiment 3 illustrates a schematic diagram of an example of a radio protocol architecture of a user plane and a control plane according to one embodiment of the present application, as shown in FIG. 3. FIG. 3 is a schematic diagram illustrating an embodiment of a radio protocol architecture of a user plane 350 and a control plane 300. In FIG. 3, the radio protocol architecture for a first communication node (UE, gNB or an RSU in V2X) and a second communication node (gNB, UE or an RSU in V2X), or between two UEs is represented by three layers, which are a layer 1, a layer 2 and a layer 3, respectively. The layer 1 (L1) is the lowest layer and performs signal processing functions of various PHY layers. The L1 is called PHY 301 in the present application. The layer 2 (L2) 305 is above the PHY 301, and is in charge of a link between a first communication node and a second communication node, as well as two UEs via the PHY 301. L2 305 comprises a Medium Access Control (MAC) sublayer 302, a Radio Link Control (RLC) sublayer 303 and a Packet Data Convergence Protocol (PDCP) sublayer 304. All the three sublayers terminate at the second communication node. The PDCP sublayer 304 provides multiplexing among variable radio bearers and logical channels. The PDCP sublayer 304 provides security by encrypting a packet and provides support for a first communication node handover between second communication nodes. The RLC sublayer 303 provides segmentation and reassembling of a higher-layer packet, retransmission of a lost packet, and reordering of a data packet so as to compensate the disordered receiving caused by HARQ. The MAC sublayer 302 provides multiplexing between a logical channel and a transport channel. The MAC sublayer 302 is also responsible for allocating between first communication nodes various radio resources (i.e., resource block) in a cell. The MAC sublayer 302 is also in charge of HARQ operation. The Radio Resource Control (RRC) sublayer 306 in layer 3 (L3) of the control plane 300 is responsible for acquiring radio resources (i.e., radio bearer) and configuring the lower layer with an RRC signaling between a second communication node and a first communication node device. The radio protocol architecture of the user plane 350 comprises layer 1 (L1) and layer 2 (L2). In the user plane 350, the radio protocol architecture for the first communication node and the second communication node is almost the same as the corresponding layer and sublayer in the control plane 300 for physical layer 351, PDCP sublayer 354, RLC sublayer 353 and MAC sublayer 352 in L2 layer 355, but the PDCP sublayer 354 also provides a header compression for a higher-layer packet so as to reduce a radio transmission overhead. The L2 layer 355 in the user plane 350 also includes Service Data Adaptation Protocol (SDAP) sublayer 356, which is responsible for the mapping between QoS flow and Data Radio Bearer (DRB) to support the diversity of traffic. Although not described in FIG. 3, the first communication node may comprise several higher layers above the L2 layer 355, such as a network layer (e.g., IP layer) terminated at a P-GW of the network side and an application layer terminated at the other side of the connection (e.g., a peer UE, a server, etc.).

In one embodiment, the radio protocol architecture in FIG. 3 is applicable to the first node in the present application.

In one embodiment, the radio protocol architecture in FIG. 3 is applicable to the second node in the present application.

In one embodiment, the first information in the present application is generated by the RRC sublayer 306.

In one embodiment, the first information in the present application is generated by the MAC sublayer 302.

In one embodiment, the first information in the present application is generated by the MAC sublayer 352.

In one embodiment, the first information in the present application is generated by the PHY 301.

In one embodiment, the first information in the present application is generated by the PHY 351.

In one embodiment, the first signaling in the present application is generated by the RRC sublayer 306.

In one embodiment, the first signaling in the present application is generated by the MAC sublayer 302.

In one embodiment, the first signaling in the present application is generated by the MAC sublayer 352.

In one embodiment, the first signaling in the present application is generated by the PHY 301.

In one embodiment, the first signaling in the present application is generated by the PHY 351.

In one embodiment, the first preamble in the present application is generated by the PHY 301.

In one embodiment, the first preamble in the present application is generated by the PHY 351.

### Embodiment 4

Embodiment 4 illustrates a schematic diagram of a first communication device and a second communication device in the present application, as shown in FIG. 4. FIG. 4 is a block diagram of a first communication device 410 in communication with a second communication device 450 in an access network.

The first communication device 410 comprises a controller/processor 475, a memory 476, a receiving processor 470, a transmitting processor 416, a multi-antenna receiving processor 472, a multi-antenna transmitting processor 471, a transmitter/receiver 418 and an antenna 420.

The second communication device 450 comprises a controller/processor 459, a memory 460, a data source 467, a transmitting processor 468, a receiving processor 456, a multi-antenna transmitting processor 457, a multi-antenna receiving processor 458, a transmitter/receiver 454 and an antenna 452.

In a transmission from the first communication device 410 to the second communication device 450, at the first communication device 410, a higher layer packet from the core network is provided to a controller/processor 475. The controller/processor 475 provides a function of the L2 layer. In the transmission from the first communication device 410 to the first communication device 450, the controller/processor 475 provides header compression, encryption, packet segmentation and reordering, and multiplexing between a logical channel and a transport channel, and radio resources allocation to the second communication device 450 based on various priorities. The controller/processor 475 is also responsible for retransmission of a lost packet and a signaling to the second communication device 450. The transmitting processor 416 and the multi-antenna transmitting processor 471 perform various signal processing functions used for the L1 layer (that is, PHY). The transmitting processor 416 performs coding and interleaving so as to ensure an FEC (Forward Error Correction) at the second communication device 450, and the mapping to signal clusters corresponding to each modulation scheme (i.e., BPSK, QPSK, M-PSK, M-QAM, etc.). The multi-antenna transmitting processor 471 performs digital spatial precoding, including codebook-based precoding and non-codebook-based precoding, and beamforming on encoded and modulated symbols to generate one or more spatial streams. The transmitting processor 416 then maps each spatial stream into a subcarrier. The mapped symbols are multiplexed with a reference signal (i.e., pilot frequency) in time domain and/or frequency domain, and then they are assembled through Inverse Fast Fourier Transform (IFFT) to generate a physical channel carrying time-domain multi-carrier symbol streams. After that the multi-antenna transmitting processor 471 performs transmission analog precoding/beamforming on the time-domain multi-carrier symbol streams. Each transmitter 418 converts a baseband multicarrier symbol stream provided by the multi-antenna transmitting processor 471 into a radio frequency (RF) stream. Each radio frequency stream is later provided to different antennas 420.

In a transmission from the first communication device 410 to the second communication device 450, at the second communication device 450, each receiver 454 receives a signal via a corresponding antenna 452. Each receiver 454 recovers information modulated to the RF carrier, converts the radio frequency stream into a baseband multicarrier symbol stream to be provided to the receiving processor 456. The receiving processor 456 and the multi-antenna receiving processor 458 perform signal processing functions of the L1 layer. The multi-antenna receiving processor 458 performs receiving analog precoding/beamforming on a baseband multicarrier symbol stream from the receiver 454. The receiving processor 456 converts the baseband multicarrier symbol stream after receiving the analog precoding/beamforming from time domain into frequency domain using FFT. In frequency domain, a physical layer data signal and a reference signal are de-multiplexed by the receiving processor 456, wherein the reference signal is used for channel estimation, while the data signal is subjected to multi-antenna detection in the multi-antenna receiving processor 458 to recover any the second communication device-targeted spatial stream. Symbols on each spatial stream are demodulated and recovered in the receiving processor 456 to generate a soft decision. Then the receiving processor 456 decodes and de-interleaves the soft decision to recover the higher-layer data and control signal transmitted on the physical channel by the first communication node 410. Next, the higher-layer data and control signal are provided to the controller/processor 459. The controller/processor 459 performs functions of the L2 layer. The controller/processor 459 can be connected to a memory 460 that stores program code and data. The memory 460 can be called a computer readable medium. In the transmission from the first communication device 410 to the second communication device 450, the controller/processor 459 provides demultiplexing between a transport channel and a logical channel, packet reassembling, decryption, header decompression and control signal processing so as to recover a higher-layer packet from the core network. The higher-layer packet is later provided to all protocol layers above the L2 layer, or various control signals can be provided to the L3 layer for processing.

In a transmission from the second communication device 450 to the first communication device 410, at the second communication device 450, the data source 467 is configured to provide a higher-layer packet to the controller/processor 459. The data source 467 represents all protocol layers above the L2 layer. Similar to a transmitting function of the first communication device 410 described in the transmission from the first communication device 410 to the second communication device 450, the controller/processor 459 performs header compression, encryption, packet segmentation and reordering, and multiplexing between a logical channel and a transport channel based on radio resources allocation so as to provide the L2 layer functions used for the user plane and the control plane. The controller/processor 459 is also responsible for retransmission of a lost packet, and a signaling to the first communication device 410. The transmitting processor 468 performs modulation mapping and channel coding. The multi-antenna transmitting processor 457 implements digital multi-antenna spatial precoding, including codebook-based precoding and non-codebook-based precoding, as well as beamforming. Following that, the generated spatial streams are modulated into multicarrier/single-carrier symbol streams by the transmitting processor 468, and then modulated symbol streams are subjected to analog precoding/beamforming in the multi-antenna transmitting processor 457 and provided from the transmitters 454 to each antenna 452. Each transmitter 454 first converts a baseband symbol stream provided by the multi-antenna transmitting processor 457 into a radio frequency symbol stream, and then provides the radio frequency symbol stream to the antenna 452.

In the transmission from the second communication device 450 to the first communication device 410, the function of the first communication device 410 is similar to the receiving function of the second communication device 450 described in the transmission from the first communication device 410 to the second communication device 450. Each receiver 418 receives a radio frequency signal via a corresponding antenna 420, converts the received radio frequency signal into a baseband signal, and provides the baseband signal to the multi-antenna receiving processor 472 and the receiving processor 470. The receiving processor 470 and multi-antenna receiving processor 472 collectively provide functions of the L1 layer. The controller/processor 475 provides functions of the L2 layer. The controller/processor 475 can be connected with the memory 476 that stores program code and data. The memory 476 can be called a computer readable medium. In the transmission from the second communication device 450 to the first communication device 410, the controller/processor 475 provides de-multiplexing between a transport channel and a logical channel, packet reassembling, decryption, header decompression, control signal processing so as to recover a higher-layer packet from the UE 450. The higher-layer packet coming from the controller/processor 475 may be provided to the core network.

In one embodiment, the first node in the present application comprises the second communication device 450, and the second node in the present application comprises the first communication device 410.

In one subembodiment of the above embodiment, the first node is a UE, and the second node is a UE.

In one subembodiment of the above embodiment, the first node is a UE, and the second node is a relay node.

In one subembodiment of the above embodiment, the first node is a relay node, and the second node is a UE.

In one subembodiment of the above embodiment, the first node is a UE, and the second node is a base station.

In one subembodiment of the above embodiment, the first node is a relay node, and the second node is a base station.

In one subembodiment of the above embodiment, the second node is a UE, and the first node is a base station.

In one subembodiment of the above embodiment, the second node is a relay node, and the first node is a base station.

In one subembodiment of the above embodiment, the second communication device 450 comprises: at least one controller/processor; the at least one controller/processor is responsible for HARQ operation.

In one subembodiment of the above embodiment, the first communication device 410 comprises: at least one controller/processor; the at least one controller/processor is responsible for HARQ operation.

In one subembodiment of the above embodiment, the first communication device 410 comprises: at least one controller/processor; the at least one controller/processor is responsible for error detection using ACK and/or NACK protocols as a way to support HARQ operation.

In one embodiment, the second communication device 450 comprises at least one processor and at least one memory. The at least one memory comprises computer program codes; the at least one memory and the computer program codes are configured to be used in collaboration with the at least one processor. The second communication device 450 at least: transmits a first preamble in a first PRACH occasion; receives a first signaling, and the first signaling adopts a first RNTI; herein, the first signaling is used to respond to a transmission of the first preamble; a first time-domain symbol is an earliest time-domain symbol of the first PRACH occasion; an index of a reference time-domain symbol and an index of a reference slot are both used to determine the first RNTI, the reference time-domain symbol is a time-domain symbol other than the first time-domain symbol, and the reference time-domain symbol belongs to the reference slot; a time-domain position of the reference time-domain symbol is related to at least one of the first PRACH occasion or the first preamble.

In one subembodiment of the above embodiment, the second communication device 450 corresponds to the first node in the present application.

In one embodiment, the second communication device 450 comprises a memory that stores a computer readable instruction program. The computer readable instruction program generates an action when executed by at least one processor. The action includes: transmitting a first preamble in a first PRACH occasion; receiving a first signaling, the first signaling adopting a first RNTI; herein, the first signaling is used to respond to a transmission of the first preamble; a first time-domain symbol is an earliest time-domain symbol of the first PRACH occasion; an index of a reference time-domain symbol and an index of a reference slot are both used to determine the first RNTI, the reference time-domain symbol is a time-domain symbol other than the first time-domain symbol, and the reference time-domain symbol belongs to the reference slot; a time-domain position of the reference time-domain symbol is related to at least one of the first PRACH occasion or the first preamble.

In one subembodiment of the above embodiment, the second communication device 450 corresponds to the first node in the present application.

In one embodiment, the first communication device 410 comprises at least one processor and at least one memory. The at least one memory comprises computer program codes; the at least one memory and the computer program codes are configured to be used in collaboration with the at least one processor. The first communication device 410 at least: receives a first preamble in a first PRACH occasion; transmits a first signaling, and the first signaling adopts a first RNTI; herein, the first signaling is used to respond to a transmission of the first preamble; a first time-domain symbol is an earliest time-domain symbol of the first PRACH occasion; an index of a reference time-domain symbol and an index of a reference slot are both used to determine the first RNTI, the reference time-domain symbol is a time-domain symbol other than the first time-domain symbol, and the reference time-domain symbol belongs to the reference slot; a time-domain position of the reference time-domain symbol is related to at least one of the first PRACH occasion or the first preamble.

In one subembodiment of the above embodiment, the first communication device 410 corresponds to the second node in the present application.

In one embodiment, the first communication device 410 comprises a memory that stores a computer readable instruction program. The computer readable instruction program generates an action when executed by at least one processor. The action includes: receiving a first preamble in a first PRACH occasion; transmitting a first signaling, the first signaling adopting a first RNTI; herein, the first signaling is used to respond to a transmission of the first preamble; a first time-domain symbol is an earliest time-domain symbol of the first PRACH occasion; an index of a reference time-domain symbol and an index of a reference slot are both used to determine the first RNTI, the reference time-domain symbol is a time-domain symbol other than the first time-domain symbol, and the reference time-domain symbol belongs to the reference slot; a time-domain position of the reference time-domain symbol is related to at least one of the first PRACH occasion or the first preamble.

In one subembodiment of the above embodiment, the first communication device 410 corresponds to the second node in the present application.

In one embodiment, at least one of the antenna 452, the transmitter 454, the multi-antenna transmitting processor 458, the transmitting processor 468, the controller/processor 459, the memory 460, or the data sources 467 is used to transmit the first preamble in the present application.

In one embodiment, at least one of the antenna 420, the receiver 418, the multi-antenna receiving processor 472, the receiving processor 470, the controller/processor 475, or the memory 476 is used to receive the first preamble in the present application.

In one embodiment, at least one of the antenna 452, the receiver 454, the multi-antenna receiving processor 458, the receiving processor 456, the controller/processor 459, the memory 460, or the data source 467 is used to receive the first signaling in the present application.

In one embodiment, at least one of the antenna 420, the transmitter 418, the multi-antenna transmitting processor 471, the transmitting processor 416, the controller/processor 475, or the memory 476 is used to transmit the first signaling in the present application.

In one embodiment, at least one of the antenna 452, the receiver 454, the multi-antenna receiving processor 458, the receiving processor 456, the controller/processor 459, the memory 460, or the data source 467 is used to receive the first information in the present application.

In one embodiment, at least one of the antenna 420, the transmitter 418, the multi-antenna transmitting processor 471, the transmitting processor 416, the controller/processor 475, or the memory 476 is used to transmit the first information in the present application.

### Embodiment 5

Embodiment 5 illustrates a flowchart of signal transmission according to one embodiment in the present application, as shown in FIG. 5. In FIG. 5, a first node U1 and a second node U2 are in communications via an air interface. In FIG. 5, the part in box F1 is optional.

The first node U1 receives first information in step S5101; transmits a first preamble in a first PRACH occasion in step S511; and receives a first signaling in step S512.

The second node U2 transmits first information in step S5201; receives a first preamble in a first PRACH occasion in step S521; and transmits a first signaling in step S522.

In embodiment 5, the first signaling adopts a first RNTI; the first signaling is used to respond to a transmission of the first preamble; a first time-domain symbol is an earliest time-domain symbol of the first PRACH occasion; an index of a reference time-domain symbol and an index of a reference slot are both used to determine the first RNTI, the reference time-domain symbol is a time-domain symbol other than the first time-domain symbol, and the reference time-domain symbol belongs to the reference slot; the reference time-domain symbol is an earliest time-domain symbol of a first reference PRACH occasion, and time-domain resources occupied by the first reference PRACH occasion are earlier than or later than time-domain resources occupied by the first reference PRACH occasion.

In one subembodiment of embodiment 5, a second reference PRACH occasion does not overlap with the first reference PRACH occasion in time domain, and the second reference PRACH occasion is used to determine a first time window, the first time window is an RAR time window for the first preamble, and the first signaling is detected by the first node U1 in the first time window.

In one subembodiment of embodiment 5, the first PRACH occasion and the first reference PRACH occasion are both associated with a same SS/PBCH block index.

In one subembodiment of embodiment 5, the first PRACH occasion and the first reference PRACH occasion are respectively associated with different SS/PBCH block indexes.

In one subembodiment of embodiment 5, a first PRACH occasion pool comprises multiple PRACH occasions, a first PRACH occasion group comprises multiple PRACH occasions, and all PRACH occasions in the first PRACH occasion group belong to the first PRACH occasion pool; the first PRACH occasion belongs to the first PRACH occasion group, and each PRACH occasion in the first PRACH occasion group is used to transmit a repetition of the first preamble, the first information is used to determine the first PRACH occasion group from the first PRACH occasion pool.

In one embodiment, the first node U1 is the first node in the present application.

In one embodiment, the second node U2 is the second node in the present application.

In one embodiment, the first node U1 is a UE.

In one embodiment, the first node U1 is a base station.

In one embodiment, the second node U2 is a base station.

In one embodiment, the second node U2 is a UE.

In one embodiment, an air interface between the second node U2 and the first node U1 is a Uu interface.

In one embodiment, an air interface between the second node U2 and the first node U1 comprises a cellular link.

In one embodiment, an air interface between the second node U2 and the first node U1 is a PC5 interface.

In one embodiment, an air interface between the second node U2 and the first node U1 comprises sidelink.

In one embodiment, an air interface between the second node U2 and the first node U1 comprises a radio interface between a base station and a UE.

In one embodiment, an air interface between the second node U2 and the first node U1 comprises a radio interface between satellite and a UE.

In one embodiment, an air interface between the second node U2 and the first node U1 comprises a radio interface between a UE and a UE.

In one embodiment, steps in dotted box F1 in FIG. 5 exist.

In one embodiment, steps in dotted box F1 in FIG. 5 do not exist.

In one embodiment, a problem to be solved in the present application comprises: how to achieve coverage enhancement of PRACH in 5G NR systems.

In one embodiment, a problem to be solved in the present application comprises: how to determine an RA-RNTI used for a same RAR corresponding to multiple PRACH transmissions.

In one embodiment, a problem to be solved in the present application comprises: how to determine a time window monitoring a same RAR corresponding to multiple PRACH transmissions.

In one embodiment, a problem to be solved in the present application comprises: how to ensure consistency in the understanding of RAR-related configurations between the communicating parties.

In one embodiment, a problem to be solved in the present application comprises: how to implement the RAR-related configuration for multiple repetitions against PRACH.

In one embodiment, the first node also transmits a first PUSCH.

In one embodiment, the second node also receives a first PUSCH.

In one embodiment, the first PUSCH is a Msg3 PUSCH.

In one embodiment, Msg3 is transmitted on the first PUSCH.

In one embodiment, an RAR UL grant carried by a PDSCH scheduled by the first signaling comprises scheduling information of the first PUSCH.

In one embodiment, the scheduling information comprises at least one of time-domain resources occupied, frequency-domain resources occupied, antenna ports adopted, MCS (Modulation and coding scheme) adopted, or TPC command.

In one embodiment, a TC-RNTI is used for scrambling initialization of the first PUSCH.

In one embodiment, the first node also receives a first PDSCH, and the first PDSCH comprises a UE contention resolution identity.

In one embodiment, the second node also transmits a first PDSCH, and the first PDSCH comprises a UE contention resolution identity.

In one embodiment, DCI format 1_0 of CRC scrambled by a TC-RNTI is used to schedule the first PDSCH.

In one embodiment, the first PDSCH is a physical downlink shared channel (PDSCH).

In one embodiment, time-domain resources occupied by the first PDSCH are later than time-domain resources occupied by the first PUSCH.

### Embodiment 6

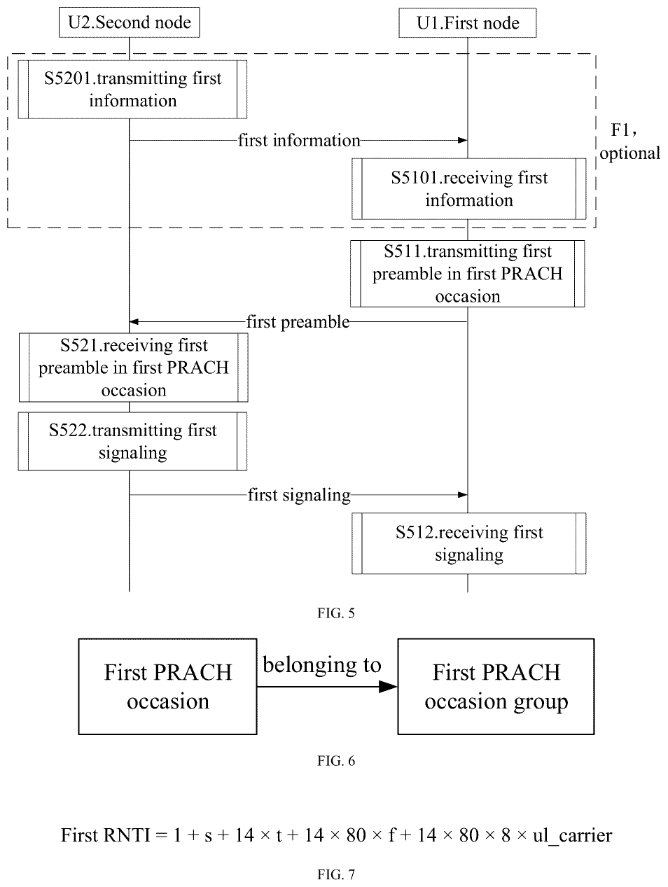

Embodiment 6 illustrate a schematic diagram of a relation between a first PRACH occasion and a first PRACH occasion group according to one embodiment of the present application, as shown in FIG. 6.

In embodiment 6, the first PRACH occasion belongs to a first PRACH occasion group, and the first PRACH occasion group comprises multiple PRACH occasions.

In one embodiment, the first PRACH occasion belongs to a first PRACH occasion group, and the reference time-domain symbol belongs to time-domain resources occupied by a PRACH occasion in the first PRACH occasion group.

In one embodiment, the first PRACH occasion belongs to a first PRACH occasion group, and the reference time-domain symbol is an earliest time-domain symbol occupied by an earliest PRACH occasion in the first PRACH occasion group.

In one embodiment, the first PRACH occasion belongs to a first PRACH occasion group, and the reference time-domain symbol is an earliest time-domain symbol occupied by a latest PRACH occasion in the first PRACH occasion group.

In one embodiment, the first PRACH occasion group comprises multiple PRACH occasions, and the multiple PRACH occasions are respectively reserved for multiple repetitions of a preamble.

In one embodiment, all PRACH occasions in the first PRACH occasion group are reserved for a same preamble.

In one embodiment, all PRACH occasions in the first PRACH occasion group are associated with a same SS/PBCH block index.

In one embodiment, an SS/PBCH block consists of a PBCH (physical broadcast channel), a PSS (Primary synchronization signal) and an SSS (Secondary synchronization signal).

In one embodiment, an SS/PBCH block index is an index of an SS/PBCH block.

In one embodiment, all PRACH occasions in the first PRACH occasion group have a same PRACH occasion index.

In one embodiment, each PRACH occasion in the first PRACH occasion group is a repetition of a same PRACH occasion.

In one embodiment, multiple PRACH occasions in the first PRACH occasion group are respectively reserved for multiple repetitions of a PRACH.

In one embodiment, the first PRACH occasion group is higher-layer signaling configured.

In one embodiment, the first PRACH occasion group is RRC signaling configured.

In one embodiment, the first PRACH occasion group is configured in an IE RACH-ConfigCommon.

In one embodiment, the first PRACH occasion group is configured in an IE RACH-ConfigDedicated.

In one embodiment, the first PRACH occasion group is configured in an IE RACH-ConfigGeneric.

In one embodiment, the first PRACH occasion group is configured in an IE whose name comprises RACH.

In one embodiment, the first PRACH occasion group is configured by an SIB signaling.

In one embodiment, the first PRACH occasion group is configured by SIB1.

In one embodiment, the first PRACH occasion group is pre-defined.

### Embodiment 7

Embodiment 7 illustrates a schematic diagram of a first RNTI according to one embodiment of the present application, as shown in FIG. 7.

In Embodiment 7, the first RNTI=1+s+14×t+14×80×f+14×80×8×ul_carrier.

In embodiment 7, s denotes the index of the reference time-domain symbol, t denotes the index of the reference slot, f is an index of a first reference PRACH occasion in frequency domain, and ul_carrier denotes a UL carrier used to transmit the first preamble (0 denotes NUL carrier, 1 denotes SUL carrier)

In one embodiment, the reference time-domain symbol is a time-domain symbol occupied by a first reference PRACH occasion in time domain.

In one embodiment, the reference time-domain symbol is an earliest time-domain symbol of a first reference PRACH occasion.

In one embodiment, the first PRACH occasion and the first reference PRACH occasion do not overlap in time domain.

In one embodiment, the first PRACH occasion only partially overlaps with the first reference PRACH occasion in time domain.

In one embodiment, the first PRACH occasion overlaps with the first reference PRACH occasion in time domain, and the reference time-domain symbol belongs to time-domain resources occupied by the first reference PRACH occasion but not to time-domain resources occupied by the first reference PRACH occasion in time domain.

In one embodiment, from a time-domain perspective, the first PRACH occasion is prior to the first reference PRACH occasion.

In one embodiment, from a time-domain perspective, the first PRACH occasion is after the first reference PRACH occasion.

In one embodiment, the first PRACH occasion and the first reference PRACH occasion respectively belong to different slots in time domain.

In one embodiment, the first PRACH occasion and the first reference PRACH occasion belong to a same slot in time domain.

In one embodiment, the first RNTI=1+s+14×t+14×80×f; herein, the s denotes the index of the reference time-domain symbol, the t denotes the index of the reference slot, and f is an index of a first reference PRACH occasion in frequency domain.

In one embodiment, f is a non-negative integer.

In one embodiment, f is not less than 0 and less than 8.

In one embodiment, the first PRACH occasion and the first reference PRACH occasion are respectively two repetitions of a same PRACH occasion.

In one embodiment, the first PRACH occasion and the first reference PRACH occasion are respectively reserved for two repetitions of a same PRACH.

In one embodiment, the first PRACH occasion and the first reference PRACH occasion both belong to the first PRACH occasion group in the present application.

### Embodiment 8

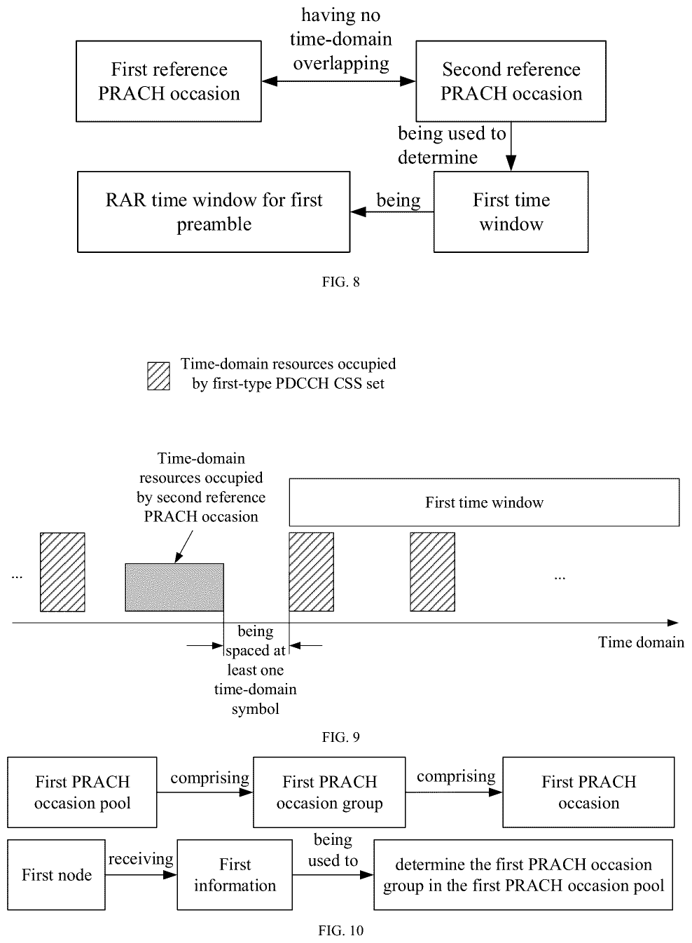

Embodiment 8 illustrates a schematic diagram of relations among a second reference PRACH occasion, a first reference PRACH occasion, a first time window and a first preamble according to one embodiment of the present application, as shown in FIG. 8.

In embodiment 8, a second reference PRACH occasion does not overlap with the first reference PRACH occasion in time domain, and the second reference PRACH occasion is used to determine a first time window, the first time window is an RAR time window for the first preamble; the first signaling is detected within the first time window.

In one embodiment, time-domain resources occupied by the second reference PRACH occasion are later than time-domain resources occupied by the first reference PRACH occasion.

In one embodiment, time-domain resources occupied by the second reference PRACH occasion are earlier than time-domain resources occupied by the first reference PRACH occasion.

In one embodiment, the second reference PRACH occasion and the first reference PRACH occasion belong to different slots in time domain.

In one embodiment, the second reference PRACH occasion and the first reference PRACH occasion belong to a same slot in time domain.

In one embodiment, the second reference PRACH occasion is the first PRACH occasion.

In one embodiment, the second reference PRACH occasion is not the first PRACH occasion.

In one embodiment, the second reference PRACH occasion and the first reference PRACH occasion are respectively two repetitions of a same PRACH occasion.

In one embodiment, the second reference PRACH occasion and the first reference PRACH occasion are respectively reserved for two repetitions of the same PRACH.

In one embodiment, the second reference PRACH occasion and the first reference PRACH occasion both belong to the first PRACH occasion group.

In one embodiment, the first reference PRACH occasion is an earliest PRACH occasion in the first PRACH occasion group.

In one embodiment, the first reference PRACH occasion is a latest PRACH occasion in the first PRACH occasion group.

In one embodiment, the first reference PRACH occasion is a first one of PRACH occasions sorted in ascending order in frequency domain first and then ascending order in time domain in the first PRACH occasion group.

In one embodiment, the first reference PRACH occasion is a last one of PRACH occasions sorted in ascending order in frequency domain first and then ascending order in time domain in the first PRACH occasion group.

In one embodiment, the first reference PRACH occasion is a first one of PRACH occasions sorted in ascending order in time domain first and then ascending order in frequency domain in the first PRACH occasion group.

In one embodiment, the first reference PRACH occasion is a last one of PRACH occasions sorted in ascending order in time domain first and then ascending order in frequency domain in the first PRACH occasion group.

In one embodiment, the second reference PRACH occasion is which PRACH occasion in the first PRACH occasion group is configurable.

In one embodiment, the second reference PRACH occasion refers to which PRACH occasion in the first PRACH occasion group is configured by an RRC signaling/message.

In one embodiment, the second reference PRACH occasion is used to indicate the first time window.

In one embodiment, the second reference PRACH occasion is used to determine a time-domain starting position of the first time window.

In one embodiment, a starting position of the first time window in time domain is not earlier than a latest time symbol occupied by the second reference PRACH occasion in time domain.

In one embodiment, the first time window starts from: an earliest time-domain symbol of an earliest CORESET configured to receive PDCCH for a Type1-PDCCH CSS set, that is at least one symbol after a latest time-domain symbol occupied by the second reference PRACH occasion in time domain.

In one embodiment, the first-type PDCCH CSS set is a Common search space set (CSS set).

In one embodiment, the first-type PDCCH CSS set is configured by ra-SearchSpace in PDCCH-ConfigCommon.

In one embodiment, the first-type PDCCH CSS set is used to detect a DCI format of CRC scrambled by an RA-RNTI or MsgB-RNTI or TC-RNTI on a primary cell.

In one embodiment, the RAR time window is used to monitor a time window of random access response (RAR).

In one embodiment, a length of the first time window is configurable.

In one embodiment, a length of the first time window is RRC-signaling configured.

In one embodiment, parameter ra-ResponseWindow is used to configure the first time window.

In one embodiment, a length of the first time window is configured by a parameter ra-Response Window.

In one embodiment, a length of the first time window is equal to a time length occupied by a positive integer number of slot(s).

In one embodiment, a length of the first time window is equal to a time length occupied by T slot(s), T is configured by ra-Response Window.

In one embodiment, the expression that “the first signaling is detected in the first time window” comprises: the first signaling is received within the first time window.

In one embodiment, the second reference PRACH occasion and the first reference PRACH occasion are both associated with a same SS/PBCH block index.

In one embodiment, the second reference PRACH and the first reference PRACH occasion are associated with different SS/PBCH block indexes, respectively.

In one embodiment, an association method between a PRACH occasion and an SS/PBCH block index is configured by an RRC signaling/message.

In one embodiment, a PRACH occasion associated with an SS/PBCH block index refers to: this PRACH occasion maps to this SS/PBCH block index.

### Embodiment 9

Embodiment 9 illustrates a schematic diagram of a second reference PRACH occasion being used to determine a first time window according to one embodiment of the present application, as shown in FIG. 9. In FIG. 9, the gray filled box denotes time-domain resources occupied by a second reference PRACH occasion, the slash-filled box denotes time-domain resources occupied by a first-type PDCCH CSS set, and the blank box denotes a first time window.

In embodiment 9, the first time window starts from: an earliest time-domain symbol of an earliest CORESET configured to receive PDCCH for a Type1-PDCCH CSS set, that is at least one symbol after a latest time-domain symbol occupied by the second reference PRACH occasion in time domain.

### Embodiment 10

Embodiment 10 illustrates a schematic diagram of relations among a first node, first information, a first PRACH occasion, a first PRACH occasion group and a first PRACH occasion pool according to one embodiment of the present application, as shown in FIG. 10.

In embodiment 10, the first node in the present application receives first information; a first PRACH occasion pool comprises multiple PRACH occasions, a first PRACH occasion group comprises multiple PRACH occasions, and all PRACH occasions in the first PRACH occasion group belong to the first PRACH occasion pool; the first PRACH occasion belongs to the first PRACH occasion group, and each PRACH occasion in the first PRACH occasion group is used to transmit a repetition of the first preamble, the first information is used to determine the first PRACH occasion group from the first PRACH occasion pool.

In one embodiment, the first information comprises at least one bit.

In one embodiment, the first information is a physical-layer signaling.

In one embodiment, the first information is DCI format.

In one embodiment, the first information is one of DCI format 0_0, DCI format 0_1 or DCI format 0_2.

In one embodiment, the first information is one of DCI format 1_0, DCI format 1_1 or DCI format 1_2.

In one embodiment, the first information comprises one or multiple fields in a DCI format.

In one embodiment, the first information is a higher-layer signaling.

In one embodiment, the first information is an RRC signaling.

In one embodiment, the first information comprises one or multiple fields in an RRC signaling.

In one embodiment, the first information comprises an IE.

In one embodiment, the first information comprises one or multiple fields in an IE.

In one embodiment, the first information is a Medium Access Control layer Control Element (MAC CE).

In one embodiment, the first information comprises one or multiple fields of a MAC CE.

In one embodiment, the first information belongs to a MAC CE.

In one embodiment, the first information comprises tdd-UL-DL-ConfigurationCommon.

In one embodiment, a name of the first information comprises TDD-UL-DL.

In one embodiment, the first information is used to configure a type of time-domain symbol.

In one embodiment, the first information is used to configure at least UL symbol(s).

In one embodiment, the first information is used to configure at least downlink symbol(s).

In one embodiment, from time-domain perspective, all PRACH occasions in the first PRACH occasion pool belong to a same PRACH configuration period.

In one embodiment, from time-domain perspective, all PRACH occasions in the first PRACH occasion pool belong to a same association period.

In one embodiment, within an association cycle, an index of each transmitted SS/PBCH block is mapped to at least one PRACH occasion.

In one embodiment, within an association cycle, an index of each transmitted SS/PBCH block is mapped to at least one valid PRACH occasion.

In one embodiment, within an association cycle, an index of each transmitted SS/PBCH block is mapped to at least one PRACH occasion group.

In one embodiment, within an association cycle, an index of each transmitted SS/PBCH block is mapped to at least one valid PRACH occasion group.

In one embodiment, the first information is used to indicate the first PRACH occasion group from the first PRACH occasion pool.

In one embodiment, the expression that “the first information is used to determine the first PRACH occasion group from the first PRACH occasion pool” comprises: the first information is used to indicate at least one PRACH occasion group from the first PRACH occasion pool, and the first PRACH occasion group is one of the indicated at least one PRACH occasion group.

In one embodiment, the expression that “the first information is used to determine the first PRACH occasion group from the first PRACH occasion pool” comprises:
the first PRACH occasion pool is divided into multiple PRACH occasion groups; the first information is used to determine at least one valid PRACH occasion group from the multiple PRACH occasion groups, and each valid PRACH occasion group in the multiple PRACH occasion groups is reserved for a transmission of a preamble; the first PRACH occasion group is a valid PRACH occasion group among the multiple PRACH occasion groups.

In one embodiment, any PRACH occasion group in the present application consists of at least one PRACH occasion.

### Embodiment 11

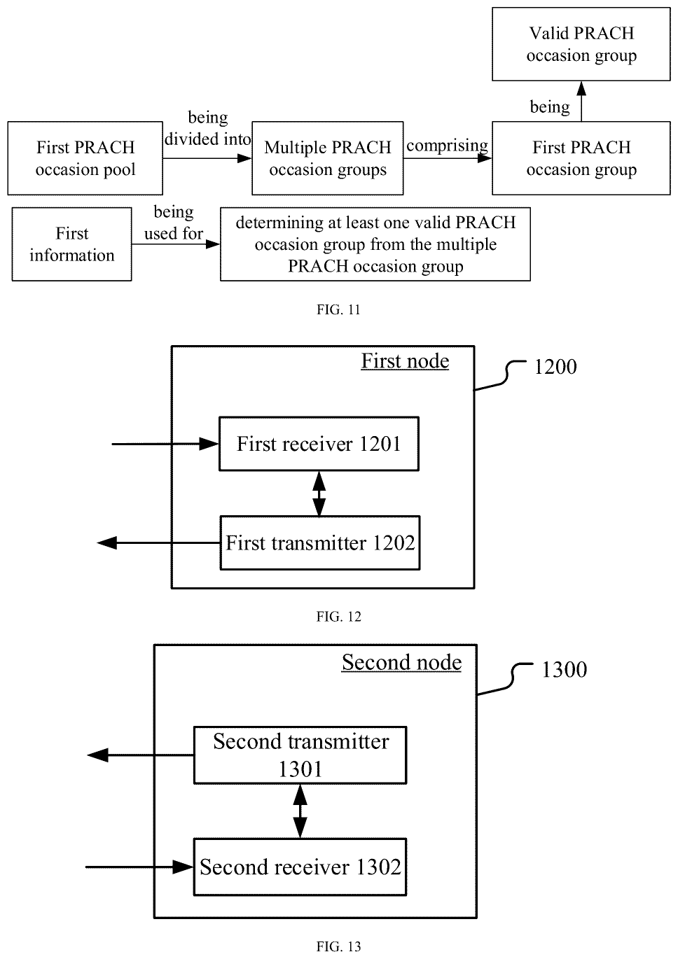

Embodiment 11 illustrates a schematic diagram of relations among first information, a first PRACH occasion group, multiple PRACH occasion group and a first PRACH occasion pool according to one embodiment of the present application, as shown in FIG. 11.

In embodiment 11, the first PRACH occasion pool is divided into multiple PRACH occasion groups; the first information is used to determine at least one valid PRACH occasion group from the multiple PRACH occasion groups, and each valid PRACH occasion group in the multiple PRACH occasion groups is reserved for a transmission of a preamble; the first PRACH occasion group is a valid PRACH occasion group among the multiple PRACH occasion groups.

In one embodiment, any two PRACH occasion groups in the multiple PRACH occasion groups comprise a same number of PRACH occasion(s).

In one embodiment, any two valid PRACH occasion groups in the multiple PRACH occasion groups comprise a same number of PRACH occasion(s).

In one embodiment, only when a PRACH occasion group comprises at least M valid PRACH occasion(s), this PRACH occasion group is a valid PRACH occasion group, M being a positive integer; the first information is used to determine whether each PRACH occasion in the first PRACH occasion pool is a valid PRACH occasion.

In one embodiment, M is equal to 1.

In one embodiment, M is greater than 1.

In one embodiment, M is equal to 2.

In one embodiment, M is equal to 3.

In one embodiment, M is equal to 4.

In one embodiment, M is equal to 5.

In one embodiment, M is equal to 6.

In one embodiment, M is equal to 7.

In one embodiment, M is equal to 8.

In one embodiment, M is not greater than 1024.

In one embodiment, M is configurable.

In one embodiment, only when all PRACH occasions in a PRACH occasion group are valid PRACH occasions, this PRACH occasion group is a valid PRACH occasion group; the first information is used to determine whether each PRACH occasion in the first PRACH occasion pool is a valid PRACH occasion.

In one embodiment, all valid PRACH occasions in each valid PRACH occasion group of the multiple PRACH occasion groups are reserved for a transmission of a preamble.

In one embodiment, the first PRACH occasion is a valid PRACH occasion.

In one embodiment, the first reference PRACH occasion is a valid PRACH occasion.

In one embodiment, the second reference PRACH occasion is a valid PRACH occasion.

In one embodiment, the first reference PRACH occasion is not a valid PRACH occasion.

In one embodiment, the second reference PRACH occasion is not a valid PRACH occasion.

In one embodiment, a valid PRACH occasion can be used to transmit a preamble.

In one embodiment, if a PRACH occasion is not a valid PRACH occasion, the PRACH occasion is not used to transmit a preamble.

In one embodiment, a valid PRACH occasion can be used for a transmission of PRACH.

In one embodiment, if a PRACH occasion is not a valid PRACH occasion, then the PRACH occasion is not used for a transmission of PRACH.

In one embodiment, the first information is used to indicate valid a PRACH occasion in the first PRACH occasion pool.

In one embodiment, the first node is provided with tdd-UL-DL-ConfigurationCommon.

In one embodiment, if all time-domain symbols occupied by a PRACH occasion in time domain are uplink symbols, then this PRACH occasion is a valid PRACH occasion.

In one embodiment, when any condition in a first condition set is satisfied, a PRACH occasion is a valid PRACH occasion; one condition in the first condition set is: all time-domain symbols occupied by this PRACH occasion in time domain are uplink symbols.

In one embodiment, one condition in the first condition set is: this PRACH occasion is not before an SS/PBCH block in the PRACH slot it belongs to, and the PRACH occasion starts at least N time-domain symbols after a last downlink symbol, and this PRACH occasion starts at least N time-domain symbols after a last time-domain symbol occupied by an SS/PBCH block, and if channelAccessMode is configured as semistatic, this PRACH occasion does not overlap with continuous time-domain symbols before the start of a next channel occupancy time where there shall not be any transmission; where N is equal to 0 or 2.

### Embodiment 12

Embodiment 12 illustrates a structure block diagram of a processor in a first node, as shown in FIG. 12. In FIG. 12, a processor 1200 in the first node is comprised of a first receiver 1201 and a first transmitter 1202.

In one embodiment, the first node 1200 is a base station.

In one embodiment, the first node 1200 is a UE.

In one embodiment, the first node 1200 is a relay node.

In one embodiment, the first node 1200 is a vehicle-mounted communication device.

In one embodiment, the first node 1200 is a UE that supports V2X communications.

In one embodiment, the first node 1200 is a relay node that supports V2X communications.

In one embodiment, the first node 1200 is a UE that supports dynamic waveform switching.

In one embodiment, the first node 1200 is a UE that supports operations on shared frequency spectrum.

In one embodiment, the first receiver 1201 comprises at least one of the antenna 452, the receiver 454, the multi-antenna receiving processor 458, the receiving processor 456, the controller/processor 459, the memory 460 or the data source 467 in FIG. 4 of the present application.

In one embodiment, the first receiver 1201 comprises at least the first five of the antenna 452, the receiver 454, the multi-antenna receiving processor 458, the receiving processor 456, the controller/processor 459, the memory 460 and the data source 467 in FIG. 4 of the present application.

In one embodiment, the first receiver 1201 comprises at least the first four of the antenna 452, the receiver 454, the multi-antenna receiving processor 458, the receiving processor 456, the controller/processor 459, the memory 460 and the data source 467 in FIG. 4 of the present application.

In one embodiment, the first receiver 1201 comprises at least the first three of the antenna 452, the receiver 454, the multi-antenna receiving processor 458, the receiving processor 456, the controller/processor 459, the memory 460 and the data source 467 in FIG. 4 of the present application.

In one embodiment, the first receiver 1201 comprises at least the first two of the antenna 452, the receiver 454, the multi-antenna receiving processor 458, the receiving processor 456, the controller/processor 459, the memory 460 and the data source 467 in FIG. 4 of the present application.

In one embodiment, the first transmitter 1202 comprises at least one of the antenna 452, the transmitter 454, the multi-antenna transmitting processor 457, the transmitting processor 468, the controller/processor 459, the memory 460, or the data source 467 in FIG. 4 of the present application.

In one embodiment, the first transmitter 1202 comprises at least first five of the antenna 452, the transmitter 454, the multi-antenna transmitting processor 457, the transmitting processor 468, the controller/processor 459, the memory 460, and the data source 467 in FIG. 4 of the present application.

In one embodiment, the first transmitter 1202 comprises at least first four of the antenna 452, the transmitter 454, the multi-antenna transmitting processor 457, the transmitting processor 468, the controller/processor 459, the memory 460, and the data source 467 in FIG. 4 of the present application.

In one embodiment, the first transmitter 1202 comprises at least first three of the antenna 452, the transmitter 454, the multi-antenna transmitting processor 457, the transmitting processor 468, the controller/processor 459, the memory 460, and the data source 467 in FIG. 4 of the present application.

In one embodiment, the first transmitter 1202 comprises at least first two of the antenna 452, the transmitter 454, the multi-antenna transmitting processor 457, the transmitting processor 468, the controller/processor 459, the memory 460, and the data source 467 in FIG. 4 of the present application.

In Embodiment 12, the first transmitter 1202 transmits a first preamble in a first PRACH occasion; the first receiver 1201 receives a first signaling, and the first signaling adopts a first RNTI; herein, the first signaling is used to respond to a transmission of the first preamble; a first time-domain symbol is an earliest time-domain symbol of the first PRACH occasion; an index of a reference time-domain symbol and an index of a reference slot are both used to determine the first RNTI, the reference time-domain symbol is a time-domain symbol other than the first time-domain symbol, and the reference time-domain symbol belongs to the reference slot; a time-domain position of the reference time-domain symbol is related to at least one of the first PRACH occasion or the first preamble.

In one embodiment, the reference time-domain symbol is an earliest time-domain symbol of a first reference PRACH occasion, and time-domain resources occupied by the first reference PRACH occasion are later than time-domain resources occupied by the first reference PRACH occasion.

In one embodiment, the first PRACH occasion and the first reference PRACH occasion are both associated with a same SS/PBCH block index.

In one embodiment, the first PRACH occasion and the first reference PRACH occasion are associated with different SS/PBCH block indexes, respectively.

In one embodiment, a second reference PRACH occasion does not overlap with the first reference PRACH occasion in time domain, and the second reference PRACH occasion is used to determine a first time window, the first time window is an RAR time window for the first preamble, and the first signaling is detected in the first time window.

In one embodiment, the first receiver 1202 receives first information; herein, a first PRACH occasion pool comprises multiple PRACH occasions, a first PRACH occasion group comprises multiple PRACH occasions, and all PRACH occasions in the first PRACH occasion group belong to the first PRACH occasion pool; the first PRACH occasion belongs to the first PRACH occasion group, and each PRACH occasion in the first PRACH occasion group is used to transmit a repetition of the first preamble, the first information is used to determine the first PRACH occasion group from the first PRACH occasion pool.

In one embodiment, the first PRACH occasion pool is divided into multiple PRACH occasion groups; the first information is used to determine at least one valid PRACH occasion group from the multiple PRACH occasion groups, and each valid PRACH occasion group in the multiple PRACH occasion groups is reserved for a transmission of a preamble; the first PRACH occasion group is a valid PRACH occasion group among the multiple PRACH occasion groups.

### Embodiment 13

Embodiment 13 illustrates a structure block diagram of a processor in a second node, as shown in FIG. 13. In FIG. 13, a processor 1300 in the second node consists of a second transmitter 1301 and a second receiver 1302.

In one embodiment, the second node 1300 is a UE.

In one embodiment, the second node 1300 is a base station.

In one embodiment, the second node 1300 is satellite.

In one embodiment, the second node 1300 is a relay node.

In one embodiment, the second node 1300 is a vehicle-mounted communication device.

In one embodiment, the second node 1300 is a UE supporting V2X communications.

In one embodiment, the second node 1300 is a device that supports dynamic waveform switching.

In one embodiment, the second node 1300 is a device that supports operations on a shared spectrum.

In one embodiment, the second transmitter 1301 comprises at least one of the antenna 420, the transmitter 418, the multi-antenna transmitting processor 471, the transmitting processor 416, the controller/processor 475 or the memory 476 in FIG. 4 of the present application.

In one embodiment, the second transmitter 1301 comprises at least the first five of the antenna 420, the transmitter 418, the multi-antenna transmitting processor 471, the transmitting processor 416, the controller/processor 475 and the memory 476 in FIG. 4 of the present application.

In one embodiment, the second transmitter 1301 comprises at least the first four of the antenna 420, the transmitter 418, the multi-antenna transmitting processor 471, the transmitting processor 416, the controller/processor 475 and the memory 476 in FIG. 4 of the present application.

In one embodiment, the second transmitter 1301 comprises at least the first three of the antenna 420, the transmitter 418, the multi-antenna transmitting processor 471, the transmitting processor 416, the controller/processor 475 and the memory 476 in FIG. 4 of the present application.

In one embodiment, the second transmitter 1301 comprises at least the first two of the antenna 420, the transmitter 418, the multi-antenna transmitting processor 471, the transmitting processor 416, the controller/processor 475 and the memory 476 in FIG. 4 of the present application.

In one embodiment, the second receiver 1302 comprises at least one of the antenna 420, the receiver 418, the multi-antenna receiving processor 472, the receiving processor 470, the controller/processor 475 or the memory 476 in FIG. 4 of the present application.

In one embodiment, the second receiver 1302 comprises at least first five of the antenna 420, the receiver 418, the multi-antenna receiving processor 472, the receiving processor 470, the controller/processor 475 and the memory 476 in FIG. 4 of the present application.

In one embodiment, the second receiver 1302 comprises at least first four of the antenna 420, the receiver 418, the multi-antenna receiving processor 472, the receiving processor 470, the controller/processor 475 and the memory 476 in FIG. 4 of the present application.

In one embodiment, the second receiver 1302 comprises at least first three of the antenna 420, the receiver 418, the multi-antenna receiving processor 472, the receiving processor 470, the controller/processor 475 and the memory 476 in FIG. 4 of the present application.

In one embodiment, the second receiver 1302 comprises at least first two of the antenna 420, the receiver 418, the multi-antenna receiving processor 472, the receiving processor 470, the controller/processor 475 and the memory 476 in FIG. 4 of the present application.

In Embodiment 13, the second receiver 1302 receives a first preamble in a first PRACH occasion; the second transmitter 1301 transmits a first signaling, and the first signaling adopts a first RNTI; herein, the first signaling is used to respond to a transmission of the first preamble; a first time-domain symbol is an earliest time-domain symbol of the first PRACH occasion; an index of a reference time-domain symbol and an index of a reference slot are both used to determine the first RNTI, the reference time-domain symbol is a time-domain symbol other than the first time-domain symbol, and the reference time-domain symbol belongs to the reference slot; a time-domain position of the reference time-domain symbol is related to at least one of the first PRACH occasion or the first preamble.

In one embodiment, the reference time-domain symbol is an earliest time-domain symbol of a first reference PRACH occasion, and time-domain resources occupied by the first reference PRACH occasion are later than time-domain resources occupied by the first reference PRACH occasion.

In one embodiment, the first PRACH occasion and the first reference PRACH occasion are both associated with a same SS/PBCH block index.

In one embodiment, the first PRACH occasion and the first reference PRACH occasion are associated with different SS/PBCH block indexes, respectively.

In one embodiment, a second reference PRACH occasion does not overlap with the first reference PRACH occasion in time domain, and the second reference PRACH occasion is used to determine a first time window, the first time window is an RAR time window for the first preamble, and the first signaling is transmitted in the first time window.

In one embodiment, the second transmitter 1301 transmits first information; herein, a first PRACH occasion pool comprises multiple PRACH occasions, a first PRACH occasion group comprises multiple PRACH occasions, and all PRACH occasions in the first PRACH occasion group belong to the first PRACH occasion pool; the first PRACH occasion belongs to the first PRACH occasion group, and each PRACH occasion in the first PRACH occasion group is used to transmit a repetition of the first preamble, the first information is used to determine the first PRACH occasion group from the first PRACH occasion pool.

In one embodiment, the first PRACH occasion pool is divided into multiple PRACH occasion groups; the first information is used to determine at least one valid PRACH occasion group from the multiple PRACH occasion groups, and each valid PRACH occasion group in the multiple PRACH occasion groups is reserved for a transmission of a preamble; the first PRACH occasion group is a valid PRACH occasion group among the multiple PRACH occasion groups.

The ordinary skill in the art may understand that all or part of steps in the above method may be implemented by instructing related hardware through a program. The program may be stored in a computer readable storage medium, for example Read-Only Memory (ROM), hard disk or compact disc, etc. Optionally, all or part of steps in the above embodiments also may be implemented by one or more integrated circuits. Correspondingly, each module unit in the above embodiment may be realized in the form of hardware, or in the form of software function modules. The first node in the present application includes but is not limited to mobile phones, tablet computers, notebooks, network cards, low-consumption equipment, enhanced MTC (eMTC) terminals, NB-IoT terminals, vehicle-mounted communication equipment, aircrafts, diminutive airplanes, unmanned aerial vehicles, telecontrolled aircrafts and other wireless communication devices. The second node in the present application includes but is not limited to mobile phones, tablet computers, notebooks, network cards, low-consumption equipment, enhanced MTC (eMTC) terminals, NB-IoT terminals, vehicle-mounted communication equipment, aircrafts, diminutive airplanes, unmanned aerial vehicles, telecontrolled aircrafts and other wireless communication devices. The UE or terminal in the present application includes but is not limited to mobile phones, tablet computers, notebooks, network cards, low-consumption equipment, enhanced MTC (eMTC) terminals, NB-IoT terminals, vehicle-mounted communication equipment, aircrafts, diminutive airplanes, unmanned aerial vehicles, telecontrolled aircrafts, etc. The base station or network side equipment in the present application includes but is not limited to macro-cellular base stations, micro-cellular base stations, home base stations, relay base station, eNB, gNB, Transmitter Receiver Point (TRP), GNSS, relay satellites, satellite base stations, space base stations, test device, test equipment, test instrument and other radio communication equipment.

It will be appreciated by those skilled in the art that this disclosure can be implemented in other designated forms without departing from the core features or fundamental characters thereof. The currently disclosed embodiments, in any case, are therefore to be regarded only in an illustrative, rather than a restrictive sense. The scope of invention shall be determined by the claims attached, rather than according to previous descriptions, and all changes made with equivalent meaning are intended to be included therein.

What is claimed is:

1. A first node for wireless communications, comprising:
a first transmitter, transmitting a first preamble in a first PRACH (Physical random access channel) occasion; and
a first receiver, receiving a first signaling, the first signaling adopting a first RNTI (Radio Network Temporary Identifier);
wherein the first signaling is used to respond to a transmission of the first preamble; a first time-domain symbol is an earliest time-domain symbol of the first PRACH occasion; an index of a reference time-domain symbol and an index of a reference slot are both used to determine the first RNTI, the reference time-domain symbol is a time-domain symbol other than the first time-domain symbol, and the reference time-domain symbol belongs to the reference slot; a time-domain position of the reference time-domain symbol is related to at least one of the first PRACH occasion or the first preamble.

2. The first node according to claim 1, wherein the reference time-domain symbol is an earliest time-domain symbol of a first reference PRACH occasion, time-domain resources of the first PRACH occasion are earlier than time-domain resources of the first reference PRACH occasion, and the first RNTI is an RA-RNTI.

3. The first node according to claim 2, wherein the first RNTI=1+s+14×t+14×80×f+14×80×8×ul_carrier; wherein s denotes the index of the reference time-domain symbol, t denotes the index of the reference slot, f is an index of the first reference PRACH occasion in frequency domain, and ul_carrier denotes a UL (uplink) carrier used to transmit the first preamble.

4. The first node according to claim 3, wherein the first PRACH occasion and the first reference PRACH occasion are both associated with a same SS/PBCH (Synchronization Signal/physical broadcast channel) block index.

5. The first node according to claim 3, wherein the first PRACH occasion and the first reference PRACH occasion do not overlap in time domain.

6. The first node according to claim 1, wherein a second reference PRACH occasion does not overlap with the first reference PRACH occasion in time domain, the second reference PRACH occasion is used to determine a first time window, the first time window is an RAR (Random Access Response) time window for the first preamble, and the first signaling is detected in the first time window.

7. The first node according to claim 1, comprising:
the first receiver, receiving first information;
wherein a first PRACH occasion pool comprises multiple PRACH occasions, a first PRACH occasion group comprises multiple PRACH occasions, and all PRACH occasions in the first PRACH occasion group belong to the first PRACH occasion pool; the first PRACH occasion belongs to the first PRACH occasion group, each PRACH occasion in the first PRACH occasion group is used to transmit a repetition of the first preamble, and the first information is used to determine the first PRACH occasion group from the first PRACH occasion pool.

8. A second node for wireless communications, comprising:
a second receiver, receiving a first preamble in a first PRACH occasion; and
a second transmitter, transmitting a first signaling, the first signaling adopting a first RNTI;
wherein the first signaling is used to respond to a transmission of the first preamble; a first time-domain symbol is an earliest time-domain symbol of the first PRACH occasion; an index of a reference time-domain symbol and an index of a reference slot are both used to determine the first RNTI, the reference time-domain symbol is a time-domain symbol other than the first time-domain symbol, and the reference time-domain symbol belongs to the reference slot; a time-domain position of the reference time-domain symbol is related to at least one of the first PRACH occasion or the first preamble.

9. The second node according to claim 8, wherein the reference time-domain symbol is an earliest time-domain symbol of a first reference PRACH occasion, time-domain resources of the first PRACH occasion are earlier than time-domain resources of the first reference PRACH occasion, and the first RNTI is an RA-RNTI.

10. The second node according to claim 9, wherein the first RNTI=1+s+14×t+14×80×f+14×80×8×ul_carrier; wherein s denotes the index of the reference time-domain symbol, t denotes the index of the reference slot, f is an index of the first reference PRACH occasion in frequency domain, and ul_carrier denotes a UL carrier used to transmit the first preamble.

11. The second node according to claim 10, wherein the first PRACH occasion and the first reference PRACH occasion are both associated with a same SS/PBCH block index.

12. The second node according to claim 10, wherein the first PRACH occasion and the first reference PRACH occasion do not overlap in time domain.

13. The second node according to claim 8, wherein a second reference PRACH occasion does not overlap with the first reference PRACH occasion in time domain, the second reference PRACH occasion is used to determine a first time window, the first time window is an RAR time window for the first preamble, and the first signaling is detected in the first time window.

14. A method in a first node for wireless communications, comprising:
transmitting a first preamble in a first PRACH occasion; and
receiving a first signaling, the first signaling adopting a first RNTI;
wherein the first signaling is used to respond to a transmission of the first preamble; a first time-domain symbol is an earliest time-domain symbol of the first PRACH occasion; an index of a reference time-domain symbol and an index of a reference slot are both used to determine the first RNTI, the reference time-domain symbol is a time-domain symbol other than the first time-domain symbol, and the reference time-domain symbol belongs to the reference slot; a time-domain position of the reference time-domain symbol is related to at least one of the first PRACH occasion or the first preamble.

15. The method in a first node according to claim 14, wherein the reference time-domain symbol is an earliest time-domain symbol of a first reference PRACH occasion, time-domain resources of the first PRACH occasion are earlier than time-domain resources of the first reference PRACH occasion, and the first RNTI is an RA-RNTI.

16. The method in a first node according to claim 15, wherein the first RNTI=1+s+14×t+14×80×f+14×80×8×ul_carrier; wherein s denotes the index of the reference time-domain symbol, t denotes the index of the reference slot, f is an index of the first reference PRACH occasion in frequency domain, and ul_carrier denotes a UL carrier used to transmit the first preamble.

17. The method in a first node according to claim 16, wherein the first PRACH occasion and the first reference PRACH occasion are both associated with a same SS/PBCH block index.

18. The method in a first node according to claim 16, wherein the first PRACH occasion and the first reference PRACH occasion do not overlap in time domain.

19. The method in a first node according to claim 14, wherein a second reference PRACH occasion does not overlap with the first reference PRACH occasion in time domain, the second reference PRACH occasion is used to determine a first time window, the first time window is an RAR time window for the first preamble, and the first signaling is detected in the first time window.

20. The method in a first node according to claim 14, comprising:
receiving first information;
wherein a first PRACH occasion pool comprises multiple PRACH occasions, a first PRACH occasion group comprises multiple PRACH occasions, and all PRACH occasions in the first PRACH occasion group belong to the first PRACH occasion pool; the first PRACH occasion belongs to the first PRACH occasion group, each PRACH occasion in the first PRACH occasion group is used to transmit a repetition of the first preamble, and the first information is used to determine the first PRACH occasion group from the first PRACH occasion pool.
